(19) United States
(12) Patent Application Publication
(10) Pub. No.: US 2020/0347505 A1
(43) Pub. Date: Nov. 5, 2020

(54) ELECTROPLATING OF SELECTIVE SURFACES FOR CONCENTRATING SOLAR COLLECTORS

(71) Applicant: ABSOLICON SOLAR COLLECTOR AB, HÄRNÖSAND (SE)

(72) Inventor: Erik ZÄLL, UMEÅ (SE)

(21) Appl. No.: 16/964,731

(22) PCT Filed: Feb. 22, 2019
(86) PCT No.: PCT/SE2019/050164

§ 371 Date: Jul. 24, 2020

(30) Foreign Application Priority Data
Feb. 22, 2018 (SE) 1850202-1

(51) Int. Cl. C25D 3/56; G02B 19/00; C25D 5/36; C25D 21/12; C25D 7/04; C25F 3/24; F24S 70/225; F24S 23/74; F24S 10/70; F24S 70/25

(52) U.S. Cl. CPC C25D 3/562; G02B 19/0019; G02B 19/0042; C25D 5/36; C25D 21/12; F24S 70/25; C25F 3/24; F24S 70/225; F24S 23/74; F24S 10/70; C25D 7/04

(57) ABSTRACT

Method of manufacturing a spectrally selective surface. The method comprises cleaning an outside of a tubular substrate, e.g. by sonicating in acetone, polishing the cleaned outside, and depositing a Co—Cr coating on the polished outside, i.e. the tubular substrate's outside. The Co—Cr coating comprises Co(II) compounds and Cr(III) compounds but no Cr(VI) compounds. By applying a DES electrolyte Cr(III)-ions may be solved in the electrolyte such that a receiver tube arranged in the electrolyte may become coated with a selective Co—Cr coating from Cr(III)-ions, where the optical characteristics regarding absorptance and emittance for the resulting receiver tube are comparable or surpasses traditional black chrome. Thereby use of harmful hexavalent chrome could be avoided, which may achieve more healthy and environmental friendly conditions. Particularly, no harmful Cr(VI)-ions or rest substances comprising them will contaminate ambient air or need to be handled or disposed.

### TECHNICAL FIELD

This disclosure relates to treatment of surfaces, especially to treatments for achieving spectrally selective surfaces for concentrating solar collectors.

### BACKGROUND

In modern society energy is consumed by people and industries, e.g. for producing various products, for transport and production of food. Energy could be produced in several forms and from different energy sources. For instance, electricity is often produced from hydroelectric power plants, combustion of coal, oil, or gas. Traditionally, heat has been produced from local combustion or district heating power plants.

With an increasing population and demands for services, energy consumption strongly increases which significantly negatively affects our environment. Combustion produces large amount of carbon dioxide and other greenhouse gases. Hydroelectric power plants require large territories to be drowned, etc.

In order to reduce our footprint and negative impression on our environment, demands have been raised for more clean and environmental friendly energy production. Today, renewable energy is produced from wind, sun, ocean waves, etc. The sun provides large amounts of energy to our planet in form of radiated sun beams. Solar radiation can be used by solar cells to generate electricity, e.g. in form of solar panels, or by solar collectors to generate thermal heat.

A concentrating solar collector uses mirrors, lenses, or combinations thereof, to focus the solar radiation in form of a point or a line. In trough-formed concentrating solar collectors a reflector is formed as a curved elongated mirror, which reflects the solar radiation on a receiver arranged along a focus-line of the reflector. The receiver is commonly a black tube filled with a transport fluid, such as water, glycol, or oil. The tube is heated by the concentrated solar radiation and the heat is transferred to the transport fluid that is circulated in a system where the heated transport fluid could be used. The heated transport fluid may be used both as process heat in industrial processes as for district heating.

The team “PTC” (Parabolic Trough solar Collector) will be used in this disclosure to denote a concentrating solar collector with a trough-formed reflector arranged to concentrate solar light onto a fluid tube. Typically, PTCs will be pivoted to track the sun during the day and are controlled by a solar tracking arrangement.

A parabolic trough solar collector comprises an elongated reflector, which reflective surface in a cross-section describes a parabolic curve. The reflector focuses direct sunlight on a focus.

Electroplating is an old and well established technique that has been used to produce selective surfaces for solar collectors since at least 1970 (Selvakumar & Barshilia, 2012), earlier referred to as [1].

The term “Selective surface” is used to denote a surface with different absorptance/emittance for different wavelengths of electromagnetic waves (i.e. radiation), e.g. high optical absorptance/emittance in a visible spectrum range and a low optical absorptance/emittance in an infrared spectrum range. Selective surfaces are also referred to as “spectrally selective surfaces” and “optically selective surfaces”. A number of metals, including nickel, cobalt and chromium, have been used to electroplate selective surfaces. Black chromium (also known as black chrome) exhibited the best optical properties (i.e. among these electroplated surfaces) and as a result electroplated black chrome became one of the most commonly used selective surfaces (Abbas, 2000), earlier referred to as [2]. However, conventional electroplating of chromium is being legally restricted because it is based upon solutions containing Cr(XI) (i.e. Cr(VI), see below) in the form of chromic acid which is carcinogenic and toxic (Zhang, et al., 2015), earlier referred to as [3].

With reference to the FIGS. 1a-c, that are schematic illustrations, three examples related to known receiver tube solutions will now be described.

FIG. 1a shows a receiver tube 100 for a solar collector, where the outside has an optically selective surface. The receiver tube 100 will therefore absorb solar radiation over the solar spectrum but be prevented from emitting IR (infrared) radiation, i.e. be prevented from loosing heat through radiation. The outside of the receiver tube 100 is covered with so called black chrome. Black chrome is a mix of metallic chrome and chromium oxides, e.g. CrO₂.

FIG. 1b schematically shows a cross section of the receiver tube 100 along the cut X-X in FIG. 1a.

The receiver tube 100 has a tubular substrate 102 of stainless steel and is covered with a coating 104 of black chrome.

FIG. 1c which is a schematic view of an arrangement for coating the tubular substrate 102. In this arrangement the tubular substrate 102 is arranged in an electrolyte. In the electrolyte hexavalent chrome, Cr(VI), is dissolved and the electrolyte comprises Cr(VI) ions. The tubular substrate 102 is connected to a power supply unit 120 as working electrode. A counter electrode 122 is also connected to the voltage source. When the power supply unit 120 applies a voltage U between the tubular substrate 102 and the counter electrode 122, where the tubular substrate 102 is the negative cathode and the counter electrode 122 is the positive anode, a current flows through the electrolyte, i.a. conveyed by the Cr(VI)-ions.

When reaching the tubular substrate 102, the positive Cr(VI)-ions undergo a reduction resulting in attaching them to the tubular substrate's 102 outside as the black chrome coating. In the FIG. 1c, the black chrome is illustrated as unfilled spheres. Even if the counter electrode 122 is schematically illustrated to facilitate the understanding, its form is more complex when put in to praxis. In order to achieve a uniform thickness of the coating the counter electrode 122 will typically encompass the tubular substrate 102 with an appropriate distance. In FIG. 1c, a reference electrode 124 is also arranged. The reference electrode 124 may improve precision when controlling the coating process to achieve an appropriate and precise structure or thickness of the coating. Also the reference electrode 124 is typically arranged with an appropriate distance to tubular substrate 102 when put into praxis.

There is a challenge to devise alternative appropriate methods for manufacturing spectrally selective surfaces with high qualitative characteristics.

### SUMMARY

It would be desirable to improve the environmental conditions in industrial production. It is an object of this disclosure to address at least one of the issues outlined above.

Further there is an object to provide a harmless mechanism that decreases environmental impacts when producing and maintaining solar collectors, without decreasing any optical characteristics for the resulting receiver tube.

These objects may be met by an arrangement according to the attached independent claims.

According to a first aspect, a method of manufacturing a spectrally selective surface on a receiver tube for a solar collector is provided. The method comprises cleaning an outside of a tubular substrate, e.g. by sonicating in acetone, polishing the cleaned outside, and depositing a Co—Cr coating on the polished outside, i.e. the tubular substrate's outside. The polishing may be performed by electropolishing.

Furthermore, depositing the Co—Cr coating may comprise arranging the tubular substrate in an electrolyte comprising Co(II)-ions and Cr(III)-ions, such that the Co—Cr coating will comprise Co(II) compounds and Cr(III) compounds. The electrolyte may be free from Cr(VI)-ions, i.e. not comprise any Cr(VI)-ions, such that the resulting Co—Cr coating will not comprise any Cr(VI) compounds.

Moreover, depositing the Co—Cr coating may be performed by electroplating the tubular substrate, where the solvent in the electrolyte is a DES (Deep Eutectic Solvent), the tubular substrate is connected as working electrode, wherein a counter electrode is arranged in the electrolyte, and wherein a power supply unit is electrically connected both to the tubular substrate and to the counter electrode and drives an electric current therebetween through the electrolyte.

The depositing may be controlled by regulating the electric current between the tubular substrate and the counter electrode.

The method may further comprise submerging the polished outside of the tubular substrate in an acidic or basic solution before depositing the Co—Cr coating such that the Co—Cr coating will be deposited on the polished outside after being submerged, i.e. be deposited on the tubular substrate's polished outside.

The method may further comprise depositing any suitable undercoatings or overcoatings for improving the receiver tube's performance and/or prolong its lifecycle, e.g. an undercoating comprising Nickel may be deposited under the Co—Cr coating for improving resistance against corrosion, or an overcoating comprising Silica may be deposited to protect the receiver tube.

According to a second aspect, a receiver tube for a solar collector is provided, where an outside of the receiver tube has a spectrally selective surface comprising a Co—Cr coating, preferably in form of Co(II) compounds and Cr(III) compounds. The Co—Cr coating may be free from any Cr(VI) compounds and have been manufacturing without use of substances comprising Cr(IV)-ions.

According to a third aspect, a solar collector may be provided that comprises an elongated parabolic trough reflector, and a receiver tube according to any above described aspects, wherein the receiver tube is arranged in the elongated parabolic reflector's focus to receive concentrated solar radiation reflected by the elongated parabolic trough reflector and to heat a transport fluid flowing through the receiver tube.

By applying a DES electrolyte Cr(III)-ions may be solved in the electrolyte such that a receiver tube arranged in the electrolyte may become coated with a selective Co—Cr coating from Cr(III)-ions, where the optical characteristics regarding absorptance and emittance for the resulting receiver tube are comparable or surpasses traditional black chrome. Thereby use of harmful hexavalent chrome could be avoided, which may achieve more healthy and environmental friendly conditions. Particularly, no harmful Cr(VI)-ions or rest substances comprising them will contaminate ambient air or need to be handled or disposed.

### BRIEF DESCRIPTION OF DRAWINGS

to The solution will now be described in more detail by means of exemplifying embodiments and with reference to the accompanying drawings, in which:

FIG. 1a-b are schematic illustrations of a receiver tube in accordance with prior art.

FIG. 1c is a schematic illustration of a coating process in accordance with prior art.

FIG. 2a-b are schematic flow charts of methods of electroplating a surface according to exemplifying embodiments.

FIG. 3 is a schematic illustration of a surface of a coating according to one exemplifying embodiment.

FIG. 4 is a schematic illustration of a cross section of a coating according to one exemplifying embodiment.

FIG. 5 is a schematic illustration of a receiver tube according to one exemplifying embodiment.

FIG. 6 is a schematic illustration of a solar collector according to one exemplifying embodiment.

FIGS. 7a-b are schematic illustrations of a process step for manufacturing a receiver tube according to one exemplifying embodiment.

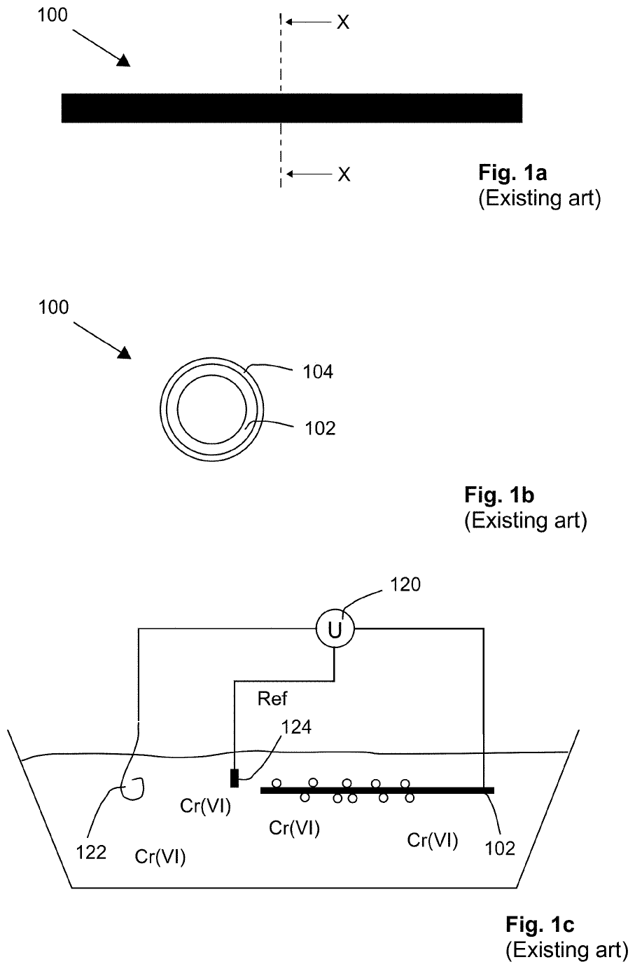

### DETAILED DESCRIPTION

To counter the above defined problem an effort is being made to replace Cr(XI) (i.e. Cr(VI), se comment below) with Cr(III) in the electroplating industry, i.e. replacing hexavalent chrome with trivalent chrome).

In this work, a spectrally selective Co—Cr coating is produced. The coating is electroplated using Cr(III) which is enabled by the DES (Deep Eutetic Solvent) based electrolyte used, significantly reducing the health-related issue.

The term DES is established within science and denotes a solvent containing a halide salt and an HBD (Hydrogen Bond Donor) (Smith, et al., 2014). These solvents have a lower melting point than the constitute components have by themselves. They also exhibit large potential windows and generally a high solubility of metal salts, making them suitable for electroplating applications (Smith, et al., 2014). Examples of halide salts and HBDs that form DESs when mixed include the halide salts Choline Chloride and Zink Chloride, and the HBDs Ethylene Glycol and Urea (Smith, et al., 2014).

On some instances throughout the corresponding Swedish patent application SE1850202-1 from which the present patent application of this disclosure claims priority, by mistake hexavalent (Cr(VI)) chrome was referred to with XI instead of VI. It is apparent that this was a typographic mistake and that hexavalent (Cr(VI)) chromium was meant.

Throughout this description ions of cobalt and chrome are referred to as e.g. Co(II), trivalent Cr(III) and hexavalent chrome Cr(VI). It is to be noted that these ions also are known as Co²⁺, Cr⁶⁺ in various publications.

### Experiment/Method

The Co—Cr coating was deposited on a stainless steel substrate. Prior to deposition the substrate was sonicated in acetone, electropolished and submerged in a weak HCl solution. The plating process was conducted in a three-electrode electrochemical cell with a Pt wire as a counter electrode and an Ag/AgCl reference electrode. The electrolyte, i.e. the plating bath consisted of CrCl₃.6H₂O and CoCl₂.6H₂O with a molar ratio of 2:1, dissolved in a DES of ethylene glycol and choline chloride with a molar ratio of 16:1. The coating was deposited by applying −1.2 V, determined by electrochemical cyclic voltammetry, for 15 min with an electrolyte temperature of 60° C.

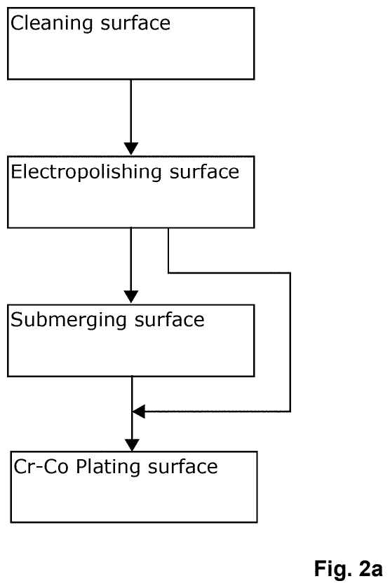

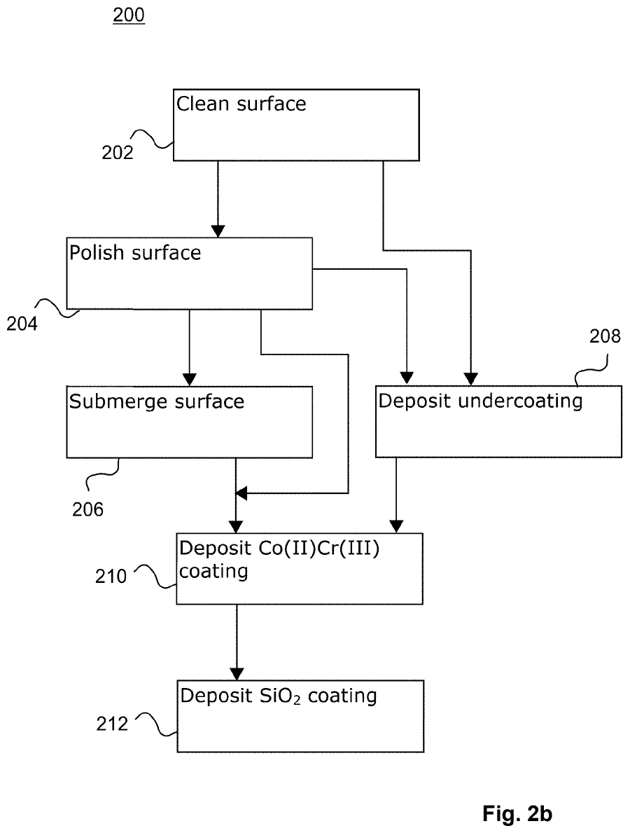

With reference to FIG. 2a (earlier numbered FIG. 3 in the corresponding Swedish patent application), which is a schematic flow chart, a method of manufacturing a spectrally selective surface will now be described in accordance with one exemplifying embodiment. This embodiment is related to the above described process.

Initially, a surface of the substrate is cleaned by sonication in acetone. In this embodiment, the substrate is a piece of stainless steel. However, the inventive concept is not limited to stainless steel, and alternative suitable materials may be applied instead when appropriate. It is also to be understood that even if sonicating the substrate in acetone is an appropriate cleaning processes, within the disclosed concept alternative cleaning processes of the substrate may be applied instead when appropriate.

In a subsequent action, the cleaned surface is electropolished, in order to improve its optical characteristics and improve its ability to receive the coating, e.g. increase its adhesive properties.

Thereafter, in a following action, the electropolished surface is coated with a Co—Cr coating, as described above. In this embodiment the coating process is performed by arranging the substrate in a solution comprising Cr(III)-ions. It is to be noted that the above defined molar ratios and temperature of the electrolyte are appropriate non-limiting selections and could be variated without deviating from the inventive concept.

When put into practice, the method typically comprises further actions which may contribute to an improved surface or a faster process, e.g. various rinse and dry actions. However, any actions which are not necessary to understand the scope has been omitted herein.

In a related exemplifying embodiment, the method further comprises an action of submerging the substrate in a weak HCl solution before depositing the Co—Cr coating, as described above. Both the actions of submerging the substrate in an acid and electropolishing it are instances of pre-treatments of the substrate surface before depositing the coating. Even though a weak HCl solution is used in this embodiment, alternative solutions may be applied instead, e.g. any appropriate acidic or basic solution.

In some above described embodiments, the plating process was performed in a three-electrode chemical cell with a Pt wire as counter electrode and an Ag/AgCl electrode as reference electrode, and where the voltage was regulated, without being limited to these materials and regulation parameters. It is to be understood that also other appropriate materials may be applied as electrodes within the disclosed concept, and that other electric parameters may be regulated. For instance, stainless steel or titanium coated with a layer of Pt may be applied as counter electrodes and the current may be regulated instead of the voltage. In addition, the pH-level of the electrolyte may be monitored and controlled, e.g. by adding appropriate buffer-substances, to ensure a desirable pH-level.

The optical properties evaluated for the surface were solar absorptance (a) and thermal emittance (c). The reflectance was measured in the region 280-1100 nm with a spectrophotometer equipped with an integrating sphere after which α was calculated using the direct 1.5 AM solar spectrum. Fourier Transform Infrared Spectroscopy (FTIR) was used to measure the reflectance in the region 2500-16000 nm, after which the blackbody spectrum at 100° C. was used to calculate c The structure of the surface and cross section as well as the thickness of the coating was investigated using Scanning Electron Microscopy (SEM), and the chemical composition was investigated using X-ray Photoelectron Spectroscopy (XPS) and Energy-Dispersive X-ray spectroscopy (EDX).

With reference to FIG. 2b, which is a schematic flow chart, a method 200 of manufacturing a spectrally selective surface at a receiver tube for a solar collector will now be described in accordance with one exemplifying embodiment. This embodiment is related to the embodiment describe above with reference to the FIG. 2a.

In an initial action 202, an outside of a tubular substrate of stainless steel is cleaned by sonicating it in acetone. This action is performed to remove impurities from the substrates surface and corresponds to the initial cleaning illustrated in FIG. 2a. However, the inventive concept is not limited to one specific cleaning process or specific material of the substrate, as discussed above. For instance, ultrasonic cleaning may be applied, or the surface may be cleaned with alternative suitable substances or chemicals.

In a subsequent action 204, the cleaned outside is polished by electropolishing, in order to improve its optical characteristics and improve its ability to receive the coating, e.g. increase its adhesive properties. The electropolishing is also made to make the cleaned outside smooth. Alternatively, the cleaned outside of the substrate may instead be polished mechanically, e.g. in combination with any suitable polishing agent.

Subsequently, in another action 210, a Co—Cr coating is deposited on the polished outside, as described above. In this embodiment the depositing is performed by arranging the substrate in an electrolyte comprising Co(II)-ions and Cr(III)-ions dissolved in a DES (Deep Eutectic Solvent). It is to be noted that the above defined molar ratios and temperature of the electrolyte are appropriate non-limiting selections and could be variated without deviating from the inventive concept. The resulting coating on the substrate's outside will then comprise Co(II) compounds and Cr(III) compounds and be deposited without using harmful hexavalent chrome Cr(VI) in any process step. In this embodiment the DES used is a mixture of choline chloride and ethylene glycol, but other suitable DESs may be applied without deviating from the disclosed inventive concept.

In this exemplifying embodiment, a power supply unit is connected to both the tubular substrate that is a working electrode and to a counter electrode that also is ananged in the electrolyte and drives an electric current through the electrolyte between the two electrodes. As will be further disclosed below in conjunction with another embodiment, the positive metal ions Co(II) and Cr(III) are attracted by the negative cathode (the working electrode) and when they reach it they undergo a reduction reaction and are attached to the polished outside of the tubular substrate as a deposited coating.

By regulating the electric current as control parameter improved precision of the deposition velocity is achieved, which may improve the reproducibility. The voltage may alternatively be used as the control parameter but results in lower precision, or may require a separate reference electrode to be arranged, which makes the arrangement more complex.

Finally, in an optional action 212, the Co—Cr coating may be covered by an overcoating to protect it from environmental impacts which else could have led to decreased functionality. For instance, the overcoating may increase thermal stability of the Co—Cr coating, improve resistance against mechanical wear, e.g. scratches, and improve resistance against corrosion and moisture related degradation. In this optional action 212, the Co—Cr coating is covered with a Silica layer, e.g. SiO₂. The Silica layer may typically be deposited by so called sol-gel dipping. The overcoating action is not limited to use Silica even if it is a beneficial material selection. Other suitable materials for the overcoating may be Boehmite (AlOOH), Titanium dioxide (TiO₂), or other suitable metal oxides.

When put into practice, the method typically comprises further actions which may contribute to an improved surface or a faster process, e.g. various rinsing and drying actions. However, any actions which are not necessary to understand the scope has been omitted herein.

However, some additional or alternative actions will be described in accordance with other exemplifying embodiments that are related to the above described ones.

I one of those related embodiments, in an intermediate action 206, performed between the polishing action 204 and the depositing action 210, the polished surface is submerged to make potential residuals or impurities that remain on the polished outside passive. Thereby, the Co—Cr coating may attach better to the polished outside. Submerging could be performed by treating the polished outside with any suitable acidic or basic solution before depositing 210 the Co—Cr coating.

It is to be noted that the term “submerging” sometimes also is referred to as “pickling” in various publications. Pickling is a metal surface treatment used to remove impurities, such as stains, inorganic contaminants, rust or scale from ferrous metals, copper, precious metals and aluminium alloys. A solution called pickle liquor, which usually contains acid, is used to remove the surface impurities. It is commonly used to descale or clean steel in various steelmaking processes.

In another of these related embodiments an intermediate action 208 of depositing an undercoating, e.g. comprising Ni (Nickel), is performed before depositing 210 the Co—Cr coating. The depositing of Ni may be performed by physical vapor deposition, electroplating, etc. This action may be performed to facilitate attaching of the Co—Cr coating. Furthermore, the Ni-undercoating may achieve lower emittance of infrared radiation when the receiver is in use and may also contribute to improved resistance against corrosion. This intermediate action 208 may be performed after the substrate's outside has been polished 204. Alternatively, the depositing of a Ni-undercoating may replace the polishing action 204. It is to be noted that even if Ni was selected as one suitable material for the undercoating in this embodiment, the inventive concept is not limited to use Ni, and other suitable undercoatings may be selected when appropriate.

### Result & Discussion

The electroplated surface is strongly selective (i.e. optically selective) as a and r are 0.97 and 0.18 respectively. The absorptance is high compared to many selective surfaces in literature (Atkinson, et al., 2015), earlier referred to as [4], however there are reports of chromium coating produced with similar methods achieving a up to 0.99 (Surviliene, et al., 2014), earlier referred to as [5]. We note here that the measurement was done in the interval 280-1100 nm and hence the entire solar spectrum is not included. Yet, this region accounts for roughly 80% of the solar irradiance making it a reasonable approximation. The trend for all solar selective surfaces is a decreasing absorptance as we move towards IR suggesting that 0.97 is a slight overestimation of a. The emittance is higher than what you would expect from a commercial selective surface. However, the combined optical performance of the surface which could be reached at about 100° C. makes it well suited for some applications, like for example in a concentrating solar collector in the mid- to low-temperature regions.

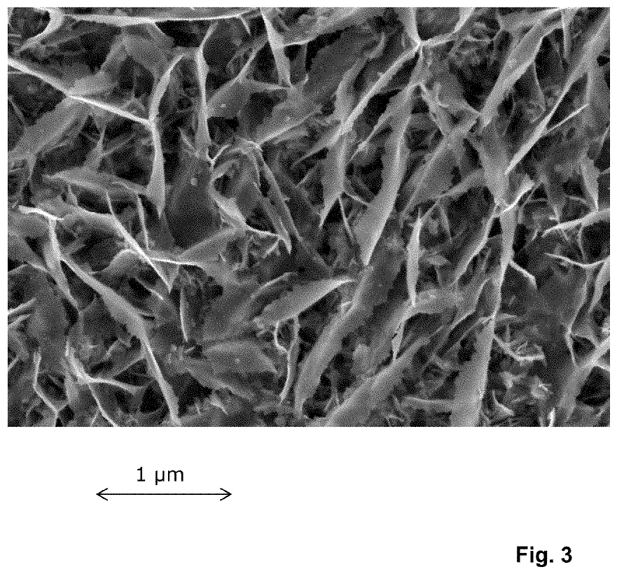

Investigation of the surface with SEM shows a surface with structures resembling sheets with cavities in between, see FIG. 3, which shows the surface of the coating. The surface is also very homogeneous (more visible when less magnified) and does not exhibit any cracks. An SEM image of the cross section of the coating reveals that the coating is approximately 2.8 μm thick and that the cavities continue throughout the entire coating, see FIG. 4, which shows a cross section of the coating, where the substrate a, the coating b, and a protective Pt layer c are shown.

EDX of the surface with 5 kV electrons revealed that the coating consists of approximately 60, 33 and 7 at % of Co, O and C respectively. However, increasing the electron energy to 10 kV results in readings of the following additional elements; 2.4, 1.5 and 0.7 at % of Cr, Fe and Cl is respectively, and EDX of the cross section of the coating gives a Cr reading of 5.2 at %. Hence, the coating consists mostly of Co compounds and the concentration of Cr is below detection limit for EDX when measured from above, but the results indicate that there is a Cr concentration gradient in the coating with higher concentration close to the substrate.

The XPS measurements confirms that the surfaces mostly consist of Co compounds with traces (<1 at %) of Cr compounds and a small amount (≈2 at %) of metallic Co. The Co-compounds constitutes approximately 50 at % of the coating and are almost exclusively cobalt hydroxides (Co—OH and Co(OH)2).

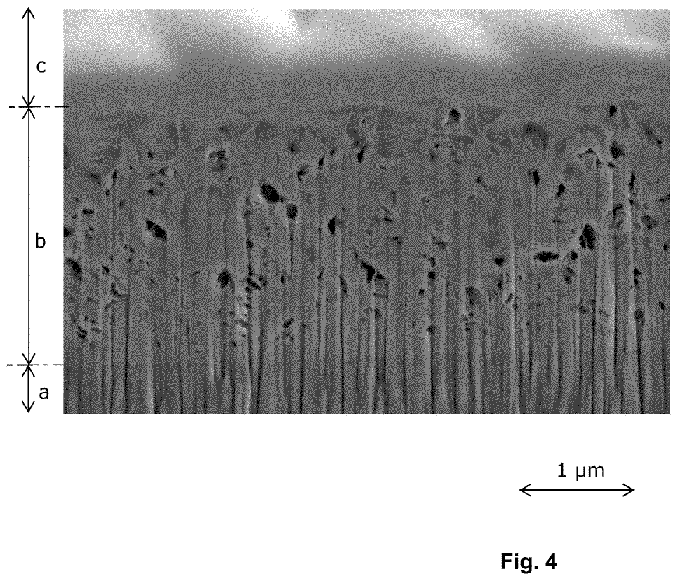

With reference to FIG. 5, which is a schematic cross-sectional view, a receiver tube 500 for a solar collector will now be described in accordance with one exemplifying embodiment.

The receiver tube 500 may be manufactured by a method of some above described embodiments. The receiver tube 500 comprises a tubular substrate 502 of stainless steel on which outside an optically selective surface is provided. In this exemplifying embodiment, the optically selective surface is provided as a Co—Cr coating 504 comprising Cr(III) compounds and Co(II) compounds.

As discussed above in conjunction with other embodiments, the Co—Cr coating 504 may be performed in an electroplating process where Cr(III)-ions but no Cr(VI)-ions are dissolved in the electrolyte. Therefore, no Cr(VI) will be present in any step of the manufacturing process or the finished product, i.e. the receiver tube.

In this embodiment, the receiver tube 500 further comprises an optional undercoating 506 deposited under the Co—Cr coating 504, i.e. between the tubular substrate 502 and the Co—Cr coating 504. The undercoating 506 comprises Ni and may achieve lower emittance of infrared radiation when the receiver is in use and may also contribute to improved resistance against corrosion.

Furthermore, the receiver tube 500 comprises an optional overcoating 508, e.g. of silica deposited on the Co—Cr coating 504. This overcoating 508 may protect the Co—Cr coating 504 from environmental impacts which else could have led to decreased functionality of the receiver tube 500, as already discussed.

It is to be noted that the undercoating 506 and the overcoating 508 may be deposited independently of each other and that the receiver tube 500 may comprise any or both of the undercoating 506 and the overcoating 508 within the disclosed concept.

Even if the cross-section is shown as circular in FIG. 5, it may be differently implemented without deviating from the disclosed inventive concept. For instance, a receiver tube 500 may be manufactured with any suitable alternative cross-sectional forms, e.g. oval, rectangular, triangular, flat, etc.

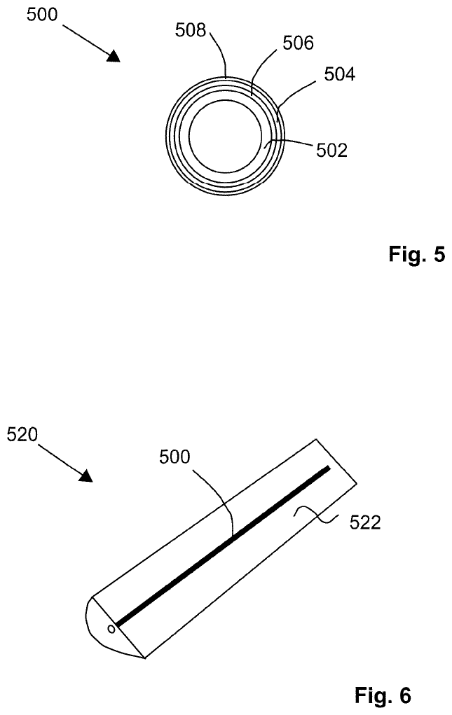

With reference to FIG. 6, which is a schematic perspective illustration, a solar collector 520 will now be described in accordance with one exemplifying embodiment.

The solar collector 520 comprises an elongated parabolic trough reflector 522 and a receiver tube 500 according to one above described embodiment. The receiver tube 500 is arranged in the reflector's 522 focus and absorbs concentrated solar radiation reflected by the reflector 522. When in use, the receiver tube 500 heats a transport fluid flowing therethrough by transferring the received solar radiation as heat. The heat may be taken care of, e.g. for industrial processes or district heating.

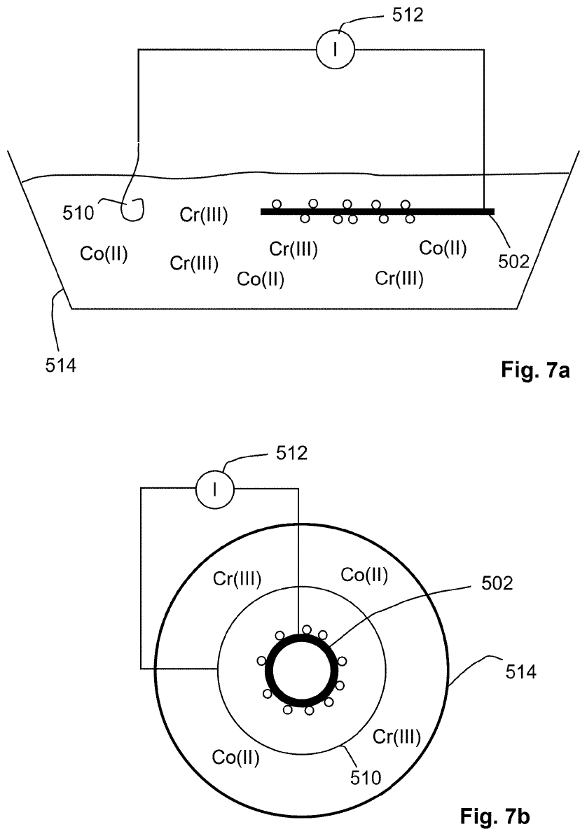

With reference to the FIGS. 7a-b, which are two schematic illustrations, an arrangement for depositing a coating on a tubular substrate will now be described in accordance with one exemplifying embodiment.

FIG. 7a is a simplified view to facilitate understanding of the electroplating process that has been described above in conjunction with another embodiment, and FIG. 7b shows an electroplating container 514 from above. In both the FIGS. 7a-b, the tubular substrate 502 is arranged as working electrode in an electrolyte and connected to a power supply unit 512. In this embodiment, the electrolyte comprises a DES of Choline Chloride and Ethylene glycol. However, the inventive concept is not limited thereto, and alternative salts and HBDs may be used instead when appropriate, e.g. Zink Chloride, and Urea, or any suitable combinations. A counter electrode 510 is also connected to the power supply unit 512. In the electrolyte chromium and cobalt salts are dissolved, resulting in an electrolyte containing Cr(III) ions (trivalent chrome) and Co(II) ions.

When the power supply unit 512 feeds an electric current through the electrolyte between the tubular substrate 502 and the counter electrode 510, the electric current is conveyed e.g. by the Cr(III)-ions and the Co(II)-ions. These positive ions undergo a reduction reaction when they reach the negative working electrode (the substrate) and are attached to the outside of the tubular substrate as a deposited coating in form of Cr(III) compounds and Co(II) compounds.

### CONCLUSIONS

The produced surface is strongly selective with α=0.97 and ϵ=0.18. These optical properties make it suitable for applications in concentrating low- to mid-temperature solar collectors. The coating is approximately 2.8 μm thick and have a porous structure both at the surface and throughout the entire coating. At the surface the porous structure resembles sheets with cavities in between. The coating consists mostly of Co hydroxides and have a Cr gradient with higher concentration at the substrate. The most abundant compounds in the coating are cobalt hydroxides and only small fractions of metallic Co and Cr compounds.

### REFERENCES

Abbas, A., 2000. Solchrome solar selective coatings—an effective way for solar water heates globally. Renewable Energy, Volym 19, pp. 145-154. Referred to as [2] in the Swedish patent application from which priority is claimed.

Atkinson, C., Sansom, C. L., Almond, H. J. & Shaw, C. P., 2015. Coatings for concentrating solar systems—A review. Renewable and Sustainable Energy Reviews, Volym 45, pp. 113-122. Referred to as [4] in the Swedish patent application from which priority is claimed.

Selvakumar, N. & Barshilia, H. C., 2012. Review of physical vapor deposited (PVD) spectrally selective coatings for mid- and high-temperature solar thermal applications. Solar Energy Materials and Solar Cells, Volym 98, pp. 1-23. Referred to as [1] in the Swedish patent application from which priority is claimed.

Smith, E. L., Abbott, A. P. & Ryder, K. S., 2014. Deep Eutectic Solvents (DESs) and Their Applications. Chemical Reviews, 114(21), pp. 11060-11082.

Surviliene, S. o.a., 2014. The use of trivalent chromium bath to obtain a solar selective black chromium coating. Applied Surface Science, Volym 305, pp. 492-497. Referred to as [5] in the Swedish patent application from which priority is claimed.

Zhang, J. o.a., 2015. Microstructure and corrosion behavior of Cr and Cr—P alloy coatings electrodeposited from a Cr(III) deep eutectic solvent. RSC Adv., 5(87), pp. 71268-71277. Referred to as [3] in the Swedish patent application from which priority is claimed.

### Numbered Exemplifying Embodiments (NEEs)

NEE1. A method of manufacturing a spectrally selective surface from a substrate, the method comprising:
cleaning a surface of the substrate, e.g. by sonicating in acetone,
electropolishing the cleaned surface, and
depositing a Co—Cr coating on the electropolished surface.

NEE2. The method according to NEE1, further comprising submerging the electropolished surface in an acidic or basic solution before depositing the Co—Cr coating.

NEE3. The method according to NEE1 or NEE2, wherein depositing the Co—Cr coating comprises arranging the electropolished surface in a solution comprising Cr(III)-ions.

Reference throughout the specification to “one embodiment” or “an embodiment” is used to mean that a particular feature, structure or characteristic described in connection with an embodiment is included in at least one embodiment.

Thus, the appearance of the expressions “in one embodiment” or “in an embodiment” in various places throughout the specification are not necessarily referring to the same embodiment. Further, the particular features, structures or characteristics may be combined in any suitable manner in one or several embodiments. Although the present invention has been described above with reference to specific embodiments, it is not intended to be limited to the specific form set forth herein. Rather, the invention is limited only by the accompanying claims and other embodiments than the specific above are equally possible within the scope of the appended claims. Moreover, it should be appreciated that the terms “comprise/comprises” or “include/includes”, as used herein, do not exclude the presence of other elements or steps.

Furthermore, although individual features may be included in different claims, these may possibly advantageously be combined, and the inclusion of different claims does not imply that a combination of features is not feasible and/or advantageous. In addition, singular references do not exclude a plurality. Finally, reference signs in the claims are provided merely as a clarifying example and should not be construed as limiting the scope of the claims in any way.

The scope is generally defined by the following independent claims. Exemplifying embodiments are defined by the dependent claims.

1-12. (canceled)

13. A method of manufacturing a spectrally selective surface on a receiver tube for a solar collector, the method comprising:
cleaning an outside of a tubular substrate, e.g. by sonicating in acetone,
polishing the cleaned outside of the tubular substrate, or depositing an undercoating at the outside of the tubular substrate, and
depositing a Co—Cr coating on the polished outside of the tubular substrate, or on the deposited undercoating, by electroplating, comprising:
arranging the tubular substrate in an electrolyte comprising Co(II)-ions and Cr(III)-ions, such that the Co—Cr coating will comprise Co(II) compounds and Cr(III) compounds,
where the solvent in the electrolyte is a Deep Eutectic Solvent, DES, the tubular substrate is connected as working electrode, wherein a counter electrode is arranged in the electrolyte, and wherein a power supply unit is electrically connected both to the tubular substrate and to the counter electrode and drives an electric current therebetween through the electrolyte.

14. The method according to claim 13, when polishing is performed, wherein polishing the cleaned outside is performed by electropolishing.

15. The method according to claim 13, wherein the electrolyte does not comprise any Cr(VI)-ions and the Co—Cr coating does not comprise any Cr(VI) compounds.

16. The method according to claim 13, wherein the depositing the Co—Cr coating is controlled by regulating the electric current between the tubular substrate and the counter electrode.

17. The method according to claim 14, further comprising submerging the polished outside of the tubular substrate in an acidic or basic solution before depositing the Co—Cr coating such that the Co—Cr coating is deposited on the polished outside after being submerged.

18. The method according to claim 14, further comprising depositing an undercoating on the polished outside of the tubular substrate before depositing the Co—Cr coating, such that the undercoating will be located between the polished surface and the deposited Co—Cr coating, the undercoating comprising Ni.

19. The method according to claim 13, further comprising depositing an overcoating on the Co—Cr coating, the overcoating comprising SiO₂.

20. A receiver tube for a solar collector, wherein an outside of the receiver tube has a spectrally selective surface comprising a Co—Cr coating in form of Co(II) compounds and Cr(III) compounds.

21. The receiver tube according to claim 20, wherein the Co—Cr coating does not comprise any Cr(VI) compounds.

22. A solar collector comprising:
an elongated parabolic trough reflector, and
a receiver tube according to claim 20 arranged in the elongated parabolic trough reflector's focus to receive concentrated solar radiation reflected by the elongated parabolic trough reflector and to heat a transport fluid flowing through the receiver tube.
